(19) United States
(12) Patent Application Publication
(10) Pub. No.: US 2012/0000222 A1
(43) Pub. Date: Jan. 5, 2012

(54) ZONE PRIORITY TEMPERATURE CONTROL IN A MULTIPLE ZONE TRANSPORT REFRIGERATION SYSTEM

(75) Inventors: Ulrich Fink, Maple Grove, MN (US); Alan D. Gustafson, Eden Prairie, MN (US); Stan Hoium, W. St. Paul, MN (US)

(73) Assignee: THERMO KING CORPORATION, Minneapolis, MN (US)

(21) Appl. No.: 12/827,595

(22) Filed: Jun. 30, 2010

(51) Int. Cl. F25B 1/00; G05D 23/32; F25B 1/10

(52) U.S. Cl. 62/115; 62/510; 62/157

(57) ABSTRACT

A multi-zone transport refrigeration system. The system includes a compressor, a condenser, a refrigerant circuit, a first temperature control zone and a second temperature control zone. A controller is configured to identify a priority zone and a non-priority zone based upon a first magnitude of a difference between a first temperature set point and a first zone temperature derived from the first air temperature sensor, and a second magnitude of a difference between the second temperature set point and a second zone temperature derived from the second air temperature sensor. A non-priority zone is isolated from the refrigerant circuit for a pre-defined period in order to maximize a refrigerant flow to the priority zone.

### BACKGROUND

The present invention relates to multi-temperature refrigeration systems. Particularly, the invention relates to transport refrigeration units that maintain multiple temperature zones within the same cargo space.

### SUMMARY

In one embodiment, the invention provides a multi-zone transport refrigeration system. A compressor has a suction side and a discharge side. A condenser is operably connected to the discharge side. A first temperature control zone has a first air temperature sensor and a first evaporator. A second temperature control zone has a second air temperature sensor and a second evaporator. A refrigerant circuit operably connects the compressor, the condenser, the first temperature control zone, and the second refrigerant zone. A first valve is configured to selectively isolate the first evaporator from the refrigerant circuit. A second valve is configured to isolate the second evaporator from the refrigerant circuit. A memory module is configured to store at least a first temperature set point associated with the first temperature control zone and a second temperature set point associated with the second temperature control zone. A controller is configured to identify a priority zone and a non-priority zone based upon a first magnitude of difference between the first temperature set point and a first zone temperature derived from the first air temperature sensor and a second magnitude of a difference between the second temperature set point and a second zone temperature derived from the second air temperature sensor. The controller operates at least one of the first valve and the second valve to isolate the non-priority zone from the refrigerant circuit for a pre-defined period to direct a refrigerant flow to the priority zone.

In another embodiment the invention provides a method of operating a multi-zone transport refrigeration system. The method includes establishing a set point temperature for each zone of the refrigeration system and selecting a zone priority control mode. An air temperature of each zone is sensed. A timer programmed to run for a pre-determined time period is started. A temperature differential for each zone is calculated based upon a magnitude difference between the sensed air temperature of each zone and the corresponding setpoint temperature. A priority zone is identified based upon magnitude difference between the actual zone temperature and the setpoint temperature. A portion of the refrigeration system associated with a non-priority zone is isolated at least until the timer expires. A portion of the refrigeration system associated with the priority zone is operated at least until the timer expires.

In yet another embodiment, the invention provides a multi-zone transport refrigeration system. A compressor has a suction side and a discharge side. A condenser is operably connected to the discharge side. A first temperature control zone includes a first air temperature sensor and a first evaporator. A second temperature control zone includes a second air temperature sensor and a second evaporator. A refrigerant circuit operably connects the compressor, the condenser, the first temperature control zone, and the second refrigerant zone. A first liquid line solenoid valve is disposed downstream of the condenser and configured to selectively isolate the first evaporator from the refrigerant circuit. A second liquid line solenoid valve is disposed downstream of the condenser and configured to selectively isolate the second evaporator from the refrigerant circuit. A memory module is configured to store at least a first temperature set point associated with the first temperature control zone and a second temperature set point associated with the second temperature control zone. A controller is configured to identify a priority zone and a non-priority zone based upon a first difference between the first temperature set point and a first zone temperature derived from the first air temperature sensor and a second difference between the second temperature set point and a second zone temperature derived from the second air temperature sensor. The controller operates at least one of the first liquid line solenoid valve and the second liquid line solenoid valve to isolate the non-priority zone from the refrigerant circuit for a pre-defined period in order to direct refrigerant flow to the priority zone and un-isolate the non-priority zone if the priority zone attains a desired operating condition prior to the pre-defined period expiring.

Other aspects of the invention will become apparent by consideration of the detailed description and accompanying drawings.

### BRIEF DESCRIPTION OF THE DRAWINGS

FIG. 1 is a block diagram of a multi-zone refrigeration system in a trailer.

FIG. 2 is a schematic of the multi-zone refrigeration system of FIG. 1.

FIG. 3 is a flow chart illustrating a method of operating a multi-zone refrigeration system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

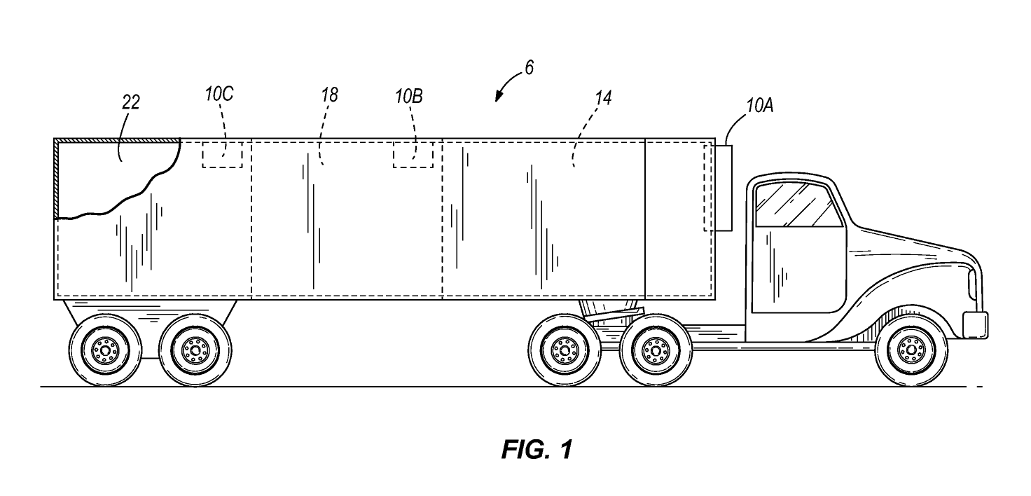

FIG. 1 is a block diagram of a truck trailer 6 with a compartmentalized, multi-temperature transport refrigeration system 10. The transport refrigeration system 10 is integrated into the trailer 6 such that a first zone 14, a second zone 18, and a third zone 22 may be individually conditioned. In other constructions, two or more than three zones may be served. In the illustrated embodiment, the first zone 14 is a front compartment, the second zone 18 is a center compartment, and the third zone 22 is a rear compartment. The refrigeration system 10 includes a main unit 10a, located within the first zone 14, and a two remote units 10B and 10C located within the second zone 18 and third zone 22, respectively. In other constructions of the invention, the compartments may be arranged side by side, top to bottom, or in other arrangements as required.

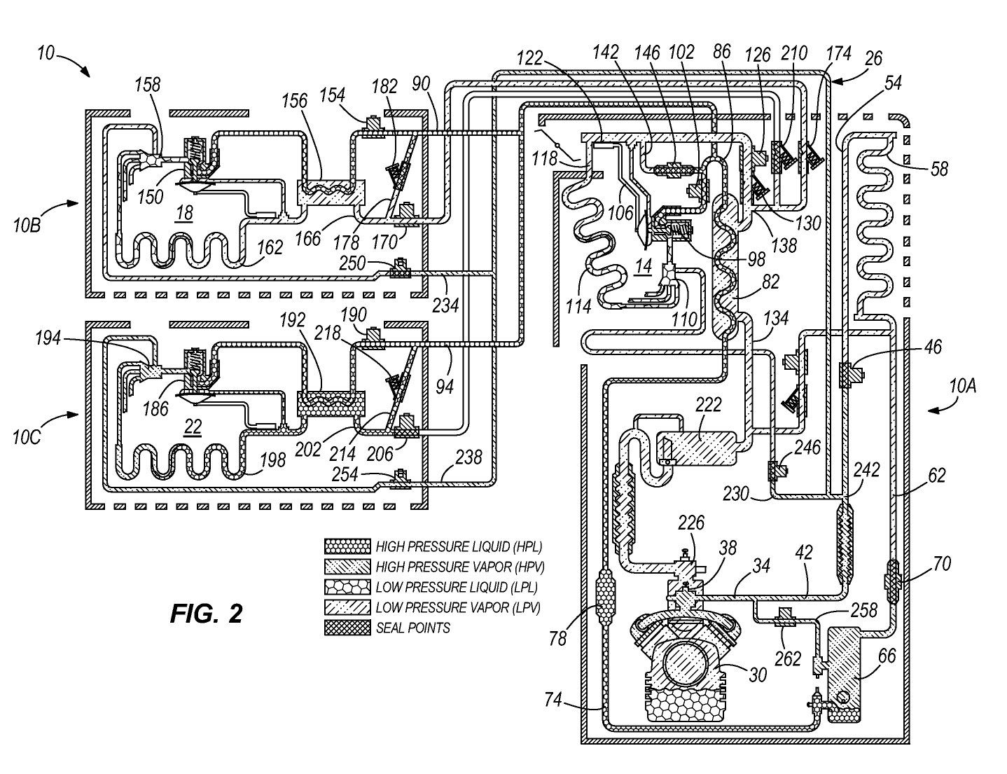

FIG. 2 is a schematic of the transport refrigeration system 10 shown in FIG. 1. The refrigeration system 10 has a closed refrigerant circuit 26, which includes a refrigerant compressor 30 driven by a prime mover arrangement (not illustrated). The prime mover arrangement may include an internal-combustion engine and a stand-by electric motor. The engine and the motor, when both are utilized, are connected to the compressor by a clutch or coupling which disengages the engine while the motor is in operation.

As explained in greater detail below, portions of the refrigerant circuit 26 flows through each of the three zones 14, 18, and 22. Those portions of the refrigerant circuit 26 associated with an individual zone are isolable from the remainder of the system by solenoid-actuated isolation valves. In particular, each zone has a respective hot gas solenoid (HGS), suction line solenoid (SLS), and liquid line solenoid (LLS). Each of these isolation valves is remotely actuated via a controller. The controller may be a microprocessor controller with an associated memory module and a user input module. In some embodiments, the controller may receive inputs from various sensors associated with the zones and refrigeration circuit. For example, each zone may at least have a supply air temperature sensor and a return air temperature sensor. The controller may be configured with both manual and automatic control of the zone isolation valves (HGS, SLS, and LLS). In a manual mode, isolation or restoration of the refrigeration circuit associated with a particular zone may be controlled by an operator with a user input panel. In an automatic mode, isolation or restoration of refrigerant flow to a zone may depend upon zone cargo, operating conditions within any of the zones, or other factors.

In the embodiment illustrated in FIG. 1, a discharge side 34 of the compressor 30 is connected to a plurality of controllable isolable valves via a discharge service valve 38 and a hot gas line 42. A first refrigerant flow path includes the hot gas line 42, a condenser inlet solenoid (CIS) 46, and a line 54 from the CIS 46 to the inlet of a condenser 58. A line 62 connects the condenser 58 to a receiver tank 66. A condenser outlet check valve 70 is disposed intermediate the condenser 58 and the receiver tank 66. A main liquid line 74, which includes a refrigerant drier 78, connects the receiver tank 66 to each of the respective zones 14, 18, and 22. The main liquid line 74 passes through a first refrigerant heat exchanger 82 and divides into a first liquid line section 86, second liquid line section 90, and third liquid line section 94. The liquid line sections correspond, respectively, to the first zone 14, second zone 18, and third zone 22.

The first liquid line section 86 extends to a first expansion valve 98 in the first zone via a first LLS 102. The first expansion valve 98 is controlled by temperature and pressure lines, indicated generally at 106. The first refrigerant flow path then continues from the first expansion valve 98 to a first refrigerant distributor 110 which distributes refrigerant to a first evaporator coil 114.

The portion of the first refrigerant flow path from the discharge service valve 38 of the compressor 30 to the first expansion valve 98 defines a first high pressure side of the system. Refrigerant discharged from the first evaporator coil 114 enters a low pressure side of the refrigerant flow path which includes a first suction line section 122. First suction line section 122, which includes a first SLS 126 and a check valve 130, is connected to a main suction line 134 at junction 138. First suction line section 122 is also connected to the first liquid line section 86 via a first by-pass line 142 which includes a first check valve 146 oriented to allow refrigerant flow from the first suction line section 122 to the first liquid line section 86.

The second liquid line section 90 extends to a second thermostatic expansion valve 150 in the second zone 18 via a second LLS 154 and a second refrigerant heat exchanger 156. The refrigerant flow path then continues from the second expansion valve 150 to a second refrigerant distributor 158 which distributes refrigerant to a second evaporator coil 162.

Refrigerant from the second evaporator coil 162 enters the low pressure side of the refrigerant flow path which includes a second suction line section 166. Second suction line section 166, which includes a second SLS 170 and a check valve 174, is connected to the main suction line 134.

Second suction line section 166 is also connected to the second liquid line section 90 via a by-pass line 178 which includes a check valve 182 oriented to allow flow from the suction line section 166 to the second liquid line section 90.

The third liquid line section 94 extends to a third expansion valve 186 in the third zone via a third LLS 190 and a third refrigerant heat exchanger 192. The first refrigerant flow path then continues from the third expansion valve 186 to a third refrigerant distributor 194 which distributes refrigerant to a third evaporator coil 198.

Refrigerant from an outlet header of evaporator coil 198 enters the low pressure side of the refrigerant flow path which includes a third suction line section 202. Third suction line section 202, which includes a third SLS 206 and a check valve 210, is connected to the main suction line 134.

The third suction line section 202 is also connected to the third liquid line section 94 via a by-pass line 214 which includes a check valve 218 oriented to allow flow from the third suction line section 202 to the third liquid line section 94.

Once all three suction lines sections recombine at 138, the main suction line 134 discharges to a refrigerant accumulator 222. A suction side 226 of compressor 30 is connected to the refrigerant accumulator 222.

The first refrigerant flow path, under the control of the controller, functions as a cooling cycle flow path for the first, second and third evaporator coils 114, 162, and 198, removing heat from the first, second, and third zones 14, 18, and 22, and rejecting heat to ambient air via the condenser coil 58. Ambient air is drawn into heat exchange relation with the condenser coil 58 via a condenser fan or blower (not shown), and heated air is discharged back to ambient.

When any of the first, second or third evaporator coils 114, 162, or 198 requires heat for defrosting, or for holding a selected set point temperature, the controller provides appropriate output signals which close the CIS and open the HGS of the unit requiring heat. Hot gas from the hot gas line is then directed into a second refrigerant flow path from a tee connected in the main hot gas line.

The second refrigerant flow path includes the hot gas line 42 that divides into first, second, and third hot gas line sections 230, 234, and 238 at tee 242. The first hot gas line section 230 extends to the first distributor 110 via a first HGS 246. The second hot gas line section 234 extends to the second distributor 158 via a second HGS 250. The third hot gas line section 238 extends to the third distributor 194 via a third HGS 254. The second refrigerant flow path then continues back to compressor 30 via the same path described relative to the first refrigerant flow path.

A third refrigerant flow path connects the discharge 34 side of the compressor 30 to the receiver tank 66 with a pressurizing line 258. The pressurizing line 258 connects to the hot gas line 42 upstream of the CIS 46. A receiver tank pressurization solenoid (RTPS) 262 functions to selectively pressurize the receiver tank 66 in response to predetermined system parameters, in order to force refrigerant within receiver tank 66 to flow into an active portion of system 10. Pressurizing line 258 is used strictly as a pressure line, enabling a relatively small tubing size to be used.

When one of the zones requires heat, other zones may be in a cooling cycle. Under these circumstances, the evaporator coil operating in a heating mode is caused to function as a condenser for the evaporator coils which are operating in a cooling mode or cycle. In the example illustrated in FIG. 1, the third zone 22 requires heat, while the first zone 14 and second zone 18 each require cooling. Under these circumstances, the controller opens the third HGS 254 and shuts the third SLS 206. All three LLS 102, 154, and 190 will be opened, and the CIS 46 will be closed. Thus, hot gas from compressor 30 will flow through hot gas line 42 to the third hot gas line section 238, through the third HGS 254, third distributor 194, and third evaporator coil 198, providing heat for defrosting the evaporator coil 192, or for maintaining the set point temperature in the third zone 22. The refrigerant in the third suction line section 202 will be forced to flow to the liquid line section 86 and 90 via the third by-pass line 94. From the liquid line sections and 90, the cooling function of the first zone 14 and second zone 18 function normally. The valve line-up illustrated in FIG. 1 is exemplary of the corresponding line-ups for providing heat to the first zone 14 or second zone 18.

As will be appreciated by those of skill in the art, refrigeration systems that control more than one zone will inherently route more refrigerant to cool or heat the zone with the greatest temperature. This effect is due to the fact that the evaporator in the zone with the highest temperature also has the highest pressure in the evaporator outlet, such that most, if not all, of the refrigerant continues to be supplied to the highest temperature evaporator. In this situation, significant warming could occur in the colder temperature zone (e.g. a frozen range space) before the system would be able to route refrigerant to the colder temperature evaporator.

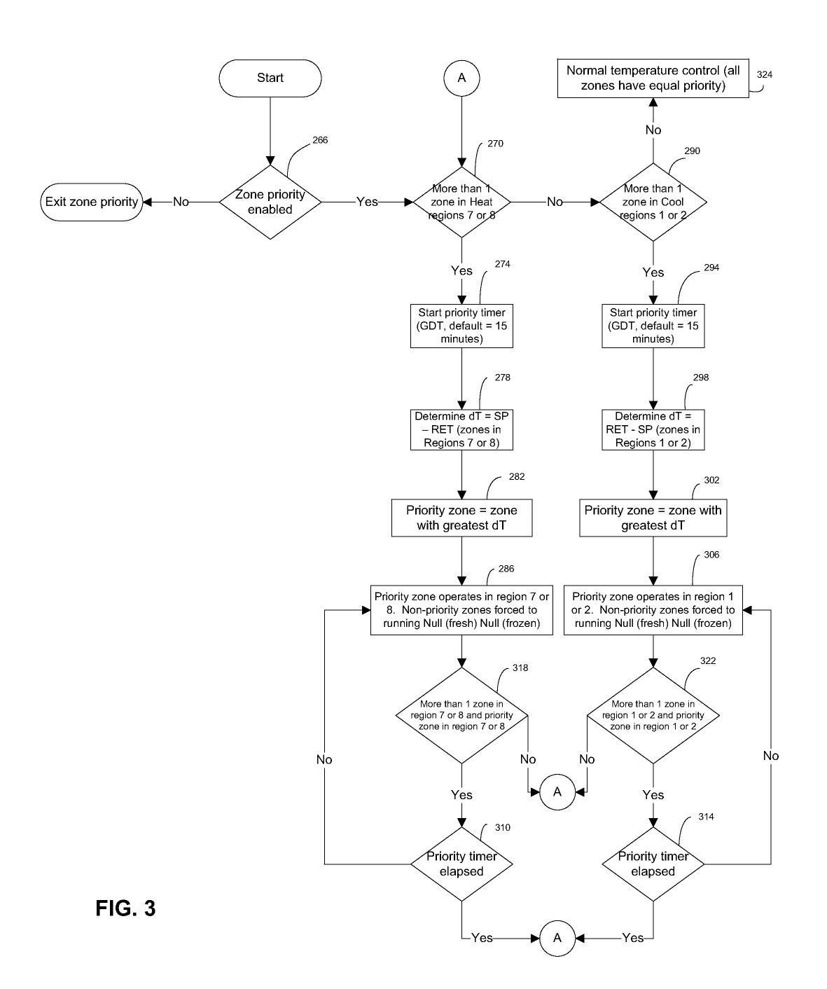

FIG. 3 is a flowchart, illustrating operation of the system 10 in a zone priority mode. Zone priority is a control method that allows zones with the greatest need for cooling or heating to receive all of the refrigerant flow for a period. In the embodiment illustrated in FIG. 2, the controller is programmed with eight control regions, with 1 requiring the highest coolest and 8 requiring the highest heating. Region 1 corresponds to high-speed cooling, region 2 corresponds to low-speed cooling, region 7 corresponds to low-speed heating and region 8 corresponds to high speed heating. When zone priority is enabled, the controller first determines if more than one zone is operating in control regions 7 or 8 (heating) or more than one zone is operating in control regions 1 or 2 (cooling). Control regions 3-6 correspond to minimal thermal loads, and therefore zone priority does no apply to these regions. In other embodiments, any number of control regions may be specified. In still other embodiments, a zone priority control regime may be implemented without specific control regions.

The control sequence of FIG. 2 begins at step 266 with determining whether zone priority is enabled. In some embodiments, zone priority may be automatically selected, while in other embodiments it may be manually selected by an operator.

At step 270, the controller determines if more than one zone is operating in heat control regions 7 or 8. If yes, than a priority timer is started at step 274. In the illustrated embodiment, the priority timer is set to a default of 15 minutes. In other embodiments, longer or shorter periods may be used. At steps 278 and 282, the controller determines which zone in a heating mode has priority based upon which zone has the greatest difference between the respective temperature set point and the respective return air temperature. At step 286, the applicable isolation valves (LLS, HGS, SLS) for the priority zone are opened (or remain open). Non-priority zones containing non-frozen (i.e. “fresh”) goods are operated in a “running null” mode. In a running null mode, those portions of the refrigerant circuit through the non-priority zones are isolated by shutting the respective HGS, LLS and SLS, but fans within the zone continue to operate. Non-priority zones containing frozen goods are operated in a “null” mode. In a null mode, the refrigerant circuit through the non-priority zones is isolated by shutting the respective HGS and LLS, and the fans are turned off.

At step 290, the controller determines if more than one zone is operating in cooling control regions 1 or 2. If yes, than a priority timer is started at step 294. In the illustrated embodiment, the priority timer is set to a default of 15 minutes. In other embodiments, longer or shorter periods may be used. At steps 298 and 302, the controller determines which zone in a cooling mode has priority based upon which zone has the greatest difference between the return air temperature and the temperature set point. At step 306, the respective isolation valves (LLS, HGS, SLS) for the priority zone are opened (or remain open). Non-priority zones containing non-frozen (i.e. “fresh”) goods are operated in a “running null” mode. In a running null mode, the refrigerant circuit through the non-priority zone is isolated by shutting the respective HGS, LLS and SLS, but fans within the zone continue to operate. Non-priority zones containing frozen goods are operated in a “null” mode. In a null mode, the refrigerant circuit through the non-priority zones is isolated by shutting the respective HGS and LLS and the fans are turned off.

For both heating and cooling in priority mode, the system continues to operate in priority mode either until the desired operating condition (e.g., a temperature set point) of the priority zone is attained or until the priority timer expires. Once the priority timer expires, at steps 310 and 314, respectively, the controller returns to the beginning of the sequence at A. However, if the priority zone attains the desired operating condition prior to the timer elapsing, the controller also returns to A at steps 318 and 322, respectively. Thus, for example, if the priority zone attains the desired operating condition (e.g. the zone enters one of control regions 3-6) in 5 minutes, a new priority zone will be established immediately rather than having to wait for the 15 minute timer to expire.

If the priority zone has attained the desired operating condition, and no more than one zone is operating in control regions 1 and 2 or 7 and 8 than the controller is returned to normal (i.e. non-priority) temperature control at step 324.

Thus, the invention provides, among other things, a system and method for zone priority control in a transport refrigeration system. Various features and advantages of the invention are set forth in the following claims.

What is claimed is:

1. A multi-zone transport refrigeration system, comprising:
a compressor having a suction side and a discharge side;
a condenser operably connected to the discharge side;
a first temperature control zone comprising
a first air temperature sensor; and
a first evaporator;
a second temperature control zone comprising
a second air temperature sensor; and
a second evaporator;
a refrigerant circuit operably connecting the compressor, the condenser, the first temperature control zone, and the second refrigerant zone;
a first valve configured to selectively isolate the first evaporator from the refrigerant circuit;
a second valve configured to selectively isolate the second evaporator from the refrigerant circuit;
a memory module configured to store at least a first temperature set point associated with the first temperature control zone and a second temperature set point associated with the second temperature control zone; and
a controller configured to
identify a priority zone and a non-priority zone based upon a first difference between the first temperature set point and a first zone temperature derived from the first air temperature sensor and a second difference between the second temperature set point and a second zone temperature derived from the second air temperature sensor and
operate at least one of the first valve and the second valve to isolate the non-priority zone from the refrigerant circuit for a pre-defined period to direct refrigerant flow to the priority zone.

2. The multi-zone transport refrigeration system of claim 1, wherein the first valve comprises a first liquid line solenoid valve disposed downstream of the condenser and the second valve comprises a second liquid line solenoid valve disposed downstream of the condenser.

3. The multi-zone transport refrigeration system of claim 2, further comprising:
a first hot gas solenoid valve configured to isolate the first evaporator from a first portion of the refrigerant circuit that bypasses the condenser; and
a second hot gas solenoid valve configured to isolate the second evaporator from a second portion of the refrigerant circuit that bypasses the condenser.

4. The multi-zone transport refrigeration system of claim 1, further comprising:
a first suction line solenoid valve disposed intermediate the first evaporator and the compressor suction side; and
a second suction line solenoid valve disposed intermediate the second evaporator and the compressor suction side.

5. The multi-zone transport refrigeration system of claim 1, wherein the first air temperature sensor is configured to measure a first return air temperature within the first temperature control zone.

6. The multi-zone transport refrigeration system of claim 5, wherein the first difference is equal to the first set point temperature minus the first return air temperature when the first temperature control zone operates in a cooling mode.

7. The multi-zone transport refrigeration system of claim 5, wherein the first difference is equal to the first return air temperature minus the first set point temperature when the first temperature control zone operates in a heating mode.

8. The multi-zone transport refrigeration system of claim 1, wherein the controller is further configured to un-isolate the non-priority zone if the priority zone attains a desired operating condition prior to the pre-defined period expiring.

9. The multi-zone transport refrigeration system of claim 1, further comprising:
a third temperature control zone comprising:
a third air temperature sensor;
a third evaporator; and
a third valve configured to selectively isolate the third evaporator from the refrigerant circuit.

10. The multi-zone transport refrigeration system of claim 9, wherein the third temperature control zone further comprises a hot gas solenoid valve and a suction line solenoid valve, and further wherein the third evaporator operates in a heating mode when the hot gas solenoid valve is open and the suction line solenoid valve is shut.

11. The multi-zone transport refrigeration system of claim 10, wherein the third evaporator functions as a condenser for the first temperature control zone and the second temperature control zone.

12. A method of operating a multi-zone transport refrigeration system, the method comprising:
establishing a set point temperature for each zone of the refrigeration system;
selecting a zone priority control mode;
sensing an air temperature of each zone;
starting a timer programmed to run for a pre-determined time period;
calculating a temperature differential for each zone based upon a difference between the sensed air temperature of each zone and the corresponding set point temperature;
identifying a priority zone and a non-priority zone based upon the temperature differentials;
isolating a portion of the refrigeration system associated with the non-priority zone at least until the timer expires; and
operating a portion of the refrigeration system associated with the priority zone at least until the timer expires.

13. The method of operating a multi-zone transport refrigeration system of claim 12, wherein the priority zone is operated in a cooling mode.

14. The method of operating a multi-zone transport refrigeration system of claim 12, wherein the priority zone is operated in a heating mode.

15. The method operating a multi-zone transport refrigeration system of claim 12, wherein the priority zone is selectively operated in one of a cooling mode and a heating mode.

16. The method of operating a multi-zone transport refrigeration system of claim 12, wherein a fan associated with the non-priority zone is operated when non-frozen goods are housed within the non-priority zone.

17. The method operating a multi-zone transport refrigeration system of claim 12, wherein a fan associated with the non-priority zone is stopped when frozen goods are housed within the non-priority zone.

18. The method of operating a multi-zone transport refrigeration system of claim 12, further comprising exiting the zone priority control mode prior to the timer expiring when a desired operating condition of the priority zone is attained.

19. The method of operating a multi-zone transport refrigeration system of claim 12, further comprising restarting the timer if the priority zone fails to attain a desired operating condition within the pre-determined time period.

20. A multi-zone transport refrigeration system, comprising:
a compressor having a suction side and a discharge side;
a condenser operably connected to the discharge side;
a first temperature control zone comprising
a first air temperature sensor; and
a first evaporator;
a second temperature control zone comprising
a second air temperature sensor; and
a second evaporator;
a refrigerant circuit operably connecting the compressor, the condenser, the first temperature control zone, and the second refrigerant zone;
a first liquid line solenoid valve disposed downstream of the condenser and configured to selectively isolate the first evaporator from the refrigerant circuit;
a second liquid line solenoid valve disposed downstream of the condenser and configured to selectively isolate the second evaporator from the refrigerant circuit;
a memory module configured to store at least a first temperature set point associated with the first temperature control zone and a second temperature set point associated with the second temperature control zone; and
a controller configured to
identify a priority zone and a non-priority zone based upon a first difference between the first temperature set point and a first zone temperature derived from the first air temperature sensor and a second difference between the second temperature set point and a second zone temperature derived from the second air temperature sensor,
operate at least one of the first liquid line solenoid valve and the second liquid line solenoid valve to isolate the non-priority zone from the refrigerant circuit for a pre-defined period to direct refrigerant flow to the priority zone, and
un-isolate the non-priority zone if the priority zone attains a desired operating condition prior to the pre-defined period expiring.
